(19) United States
(12) Patent Application Publication
(10) Pub. No.: US 2024/0143689 A1
(43) Pub. Date: May 2, 2024

(54) DIVERSITY-AWARE MULTI-OBJECTIVE HIGH DIMENSIONAL PARAMETER OPTIMIZATION USING INVERTIBLE MODELS

(71) Applicant: SRI International, Menlo Park, CA (US)

(72) Inventors: Susmit Jha, Redwood City, CA (US); Adam Derek Cobb, Washington, DC (US); Anirban Roy, San Francisco, CA (US); Daniel Elenius, Redwood City, CA (US); Patrick Denis Lincoln, Woodside, CA (US)

(21) Appl. No.: 18/489,777

(22) Filed: Oct. 18, 2023

Related U.S. Application Data
(60) Provisional application No. 63/381,075, filed on Oct. 26, 2022.

(51) Int. Cl. G06F 17/11

(52) U.S. Cl. CPC G06F 17/11

(57) ABSTRACT

In an example, a method of designing a system or architecture includes, receiving a plurality of parameter values and a set of requirements for a plurality of objective functions related to a design problem; compressing the plurality of parameters to generate a latent representation; forward processing, with one or more Invertible Neural Networks (INNs), the latent representation to generate a plurality of objective values corresponding to the plurality of the objective functions; inverse processing the plurality of objective values; and generating, based on the latent representation, a plurality of solutions to the design problem that satisfy the set of requirements for the plurality of objective functions.

This application claims the benefit of U.S. Patent Application No. 63/381,075, filed Oct. 26, 2022, which is incorporated by reference herein in its entirety.

### GOVERNMENT RIGHTS

This invention was made with Government support under contract number. FA8750-20-C-0002 awarded by the United States Air Force and the Defense Advanced Research Projects Agency, and under grant number CNS-1740079 awarded by the National Science Foundation. The Government has certain rights in this invention.

### TECHNICAL FIELD

This disclosure is related to machine learning systems, and more specifically to parameter optimization.

### BACKGROUND

Many design and configuration problems are complex and challenging to solve because they involve a large number of parameters and several objectives that need to be optimized together. These parameters are often interdependent. In other words, changing one parameter can affect the value of other parameters. Such interdependency makes it difficult to find a solution that optimizes all of the objectives simultaneously. The design of a propulsion chain for an electric-powered air vehicle is a good example of this type of problem. The propulsion chain may consist of the motors, propellers, and batteries that power the aircraft. The number of propellers, number of rotors in each propeller, length of the rotor blades, the pitch of rotor blades, motor constants, and battery parameters are all parameters that need to be configured to optimize the performance of the aircraft.

An optimal propulsion chain for an electric-powered air vehicle would need to be configured to meet a number of objectives, such as, but not limited to, maximum endurance, minimum thrust requirement, current drawn below some threshold, propulsion efficiency above some rating, maximum velocity reached above a given threshold, and the like. These objectives are often conflicting, meaning that optimizing one objective may make it more difficult to optimize another objective. For example, increasing the number of propellers will increase the thrust and efficiency of the propulsion chain, but it will also increase the weight and drag of the aircraft, which will reduce the endurance. The design of a deep neural network architecture is another example of a design and configuration problem with multiple objectives. The objectives in this case might be: minimum accuracy across different domains, maximum inference-time threshold, reduced energy consumption, minimized memory size, and the like.

### SUMMARY

The disclosure describes techniques that involve using deep/neural machine learning (ML) models and latent space learning for diversity-aware multi-objective high dimensional parameter optimization. Invertible ML models are models that may be reversed. In other words, given an output, the invertible model may be used to find the input that produced that output. The aforementioned property makes invertible ML models useful for parameter optimization, for it allows the model to be used to explore the space of possible parameters and find solutions that meet the desired objectives. Latent space learning is a technique that uses ML models to learn a latent representation of the data.

A machine learning system implementing the disclosed techniques may start with a sample of assignment of random values to parameters. The values may then be evaluated through available “black boxes.” Black boxes for a given problem space or domain may be functions that represent the different objectives of the problem. For example, in the vehicle design problem, one of the black boxes might be a function that calculates the total weight of the vehicle. The results of the black box evaluations are used to learn an autoencoder. An autoencoder is a type of neural network that can learn to map a high-dimensional space to a low-dimensional space. In this case, the high-dimensional space is the space of all possible parameter assignments, and the low-dimensional space is the latent space. The autoencoder may be trained to reconstruct the original parameters from the latent space. In other words, the autoencoder may learn to find a low-dimensional representation of the parameters that preserves the important information about the parameters. Once the autoencoder is trained, a set of surrogate models may be learned to map the latent space to the different objectives.

The techniques may provide one or more technical advantages that realize at least one practical application. For example, the disclosed techniques may enable configuring parameters for large scale systems with a very large number of parameters (e.g., hundreds) with a large number of objective functions (e.g., tens). Such a task may be difficult to perform with traditional methods, as it may be computationally expensive and time-consuming to explore the space of all possible solutions. Some of the benefits of the disclosed techniques may include finding multiple solutions for optimal parameters, from which a configuration may be selected based on additional criteria or human preference.

The techniques described in the disclosure may be applied to a variety of problems, such as optimizing the hyperparameters of ML models, determining the parameters of a propulsion chain, and so on. The following are some specific examples of how the disclosed techniques could be used. In the vehicle design problem, the disclosed techniques may be used to find a set of parameters that minimizes the total weight of the vehicle while simultaneously maximizing the number of common gauge parts. In the optimization of ML models, the disclosed techniques may be used to find a set of hyperparameters that results in the best performance of the model. In the determination of the parameters of a propulsion chain, the disclosed techniques may be used to find a set of parameters that maximizes the efficiency of the propulsion chain.

In an example, a method of designing a system or architecture includes, receiving a plurality of parameter values and a set of requirements for a plurality of objective functions related to a design problem; compressing the plurality of parameters to generate a latent representation; forward processing, with one or more Invertible Neural Networks (INNs), the latent representation to generate a plurality of objective values corresponding to the plurality of the objective functions; inverse processing the plurality of objective values; and generating, based on the latent representation, a plurality of solutions to the design problem that satisfy the set of requirements for the plurality of objective functions.

In an example, a computing system comprises: an input device configured to receive a plurality of parameter values and a set of requirements for a plurality of objective functions related to a design problem; processing circuitry and memory for executing a machine learning system, wherein the machine learning system is configured to: compress the plurality of parameters to generate a latent representation; forward process, with one or more Invertible Neural Networks (INNs), the latent representation to generate a plurality of objective values corresponding to the plurality of the objective functions; inverse process, with the one or more INNs, the plurality of objective values; and generate, based on the latent representation, a plurality of solutions to the design problem that satisfy the set of requirements for the plurality of objective functions.

In an example, non-transitory computer-readable media comprises machine readable instructions for configuring processing circuitry to: receive a plurality of parameter values and a set of requirements for a plurality of objective functions related to a design problem; compress the plurality of parameters to generate a latent representation; forward process, with one or more Invertible Neural Networks (INNs), the latent representation to generate a plurality of objective values corresponding to the plurality of the objective functions; inverse process, with the one or more INNs, the plurality of objective values; and generate, based on the latent representation, a plurality of solutions to the design problem that satisfy the set of requirements for the plurality of objective functions.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 illustrates conceptual architecture of an example optimization system in accordance with the techniques of the disclosure.

FIG. 2 is a block diagram illustrating an example system in accordance with the techniques of the disclosure.

FIG. 3 is a conceptual diagram illustrating an example inverse problem design according to techniques of this disclosure.

FIGS. 4A and 4B are conceptual diagrams illustrating example invertible neural net frameworks according to techniques of this disclosure.

FIG. 5 is a conceptual diagram illustrating an example autoencoder according to techniques of this disclosure.

FIG. 6 is a flowchart illustrating an example mode of operation for a machine learning system, according to techniques described in this disclosure.

Like reference characters refer to like elements throughout the figures and description.

### DETAILED DESCRIPTION

The disclosure describes techniques for configuring or designing a system having interdependent parameters. The interdependent parameters may be related to each other in complex ways, and it may be difficult to find a set of values for the parameters that optimizes all of the objectives.

Current approaches for multi-objective black box optimization may be categorized into two main types: gradient-free methods and gradient-based methods. Gradient-free methods do not require the knowledge of the gradient of the objective function. These methods are typically based on heuristics or metaheuristics, such as genetic algorithms, particle swarm optimization, and simulated annealing. Gradient-free methods are generally less computationally expensive than gradient-based methods, but they may be less accurate. Gradient-based methods require the knowledge of the gradient of the objective function.

Gradient-based methods are typically based on optimization algorithms such as, but not limited to gradient descent and Newton's method. Gradient-based methods may be more accurate than gradient-free methods, but they may also be more computationally expensive.

Both gradient-free and gradient-based methods have limitations. Gradient-free methods cannot exploit the smoothness of the objective function, and they may be trapped in local optima. Gradient-based methods require the gradient of the objective function, which may not be available or may be difficult to compute.

In addition, both gradient-free and gradient-based methods are unable to exploit dependencies or invariances in the parameter space. For example, in the propulsion chain for air vehicles, larger diameter propellers will need smaller motors to achieve high efficiency. This dependency cannot be captured by either gradient-free or gradient-based methods. Finally, existing methods do not produce diverse solutions. In other words, existing methods tend to find similar solutions, which may be limiting in some applications.

The following are some of the challenges in multi-objective black box optimization. The objective functions are often non-convex and noisy, which makes it difficult to find the global optimum. The number of parameters may be large, which makes it computationally expensive to evaluate the objective functions. The dependencies and invariances in the parameter space may be complex, making it difficult to exploit them. The need to find diverse solutions may make the optimization problem even more difficult.

The disclosed techniques may use machine learning to learn a latent space of the interdependent parameters. A latent space is a lower-dimensional representation of the original space of parameters. The latent space should preserve the important information about the parameters, such as their relationships with each other.

Once the latent space is learned, surrogate models may be learned for the black boxes. Surrogate models are simpler models that may be used to approximate the black boxes. The surrogate models may be used to explore the latent space and find new parameter assignments that are likely to be good solutions to the problem. The disclosed techniques may be used for: 1) solving problems with a very large number of parameters; 2) solving problems with multiple objectives; 3) finding solutions that are diverse.

Following are some specific examples of how the proposed techniques could be used. In the design of a new aircraft, the disclosed techniques may be used to find a set of parameters that minimizes the weight of the aircraft while simultaneously maximizing its fuel efficiency. In the optimization of a manufacturing process, the disclosed techniques may be used to find a set of parameters that minimizes the cost of the process while simultaneously maximizing the quality of the product. In the design of a new drug, the disclosed techniques may be used to find a set of parameters that maximizes the efficacy of the drug while minimizing its side effects.

The present disclosure describes techniques that may assign a sample of random values to parameters. The values may then be evaluated through available black boxes. Black boxes for a given problem space or domain may be functions that represent the different objectives of the problem. For example, in the vehicle design problem, one of the black boxes might be a function that calculates the total weight of the vehicle. The results of the black box evaluations may be used to learn an autoencoder. An autoencoder is a type of neural network that can learn to map a high-dimensional space to a low-dimensional space. In this case, the high-dimensional space is the space of all possible parameter assignments, and the low-dimensional space is the latent space. The autoencoder may be pretrained to reconstruct the original parameters from the latent space.

In summary, the autoencoder may learn to find a low-dimensional representation of the parameters that preserves the important information about the parameters. Once the autoencoder is trained, a set of surrogate models may be learned to map the latent space to the different objectives. Surrogate models are simpler models that may be used to approximate the black boxes.

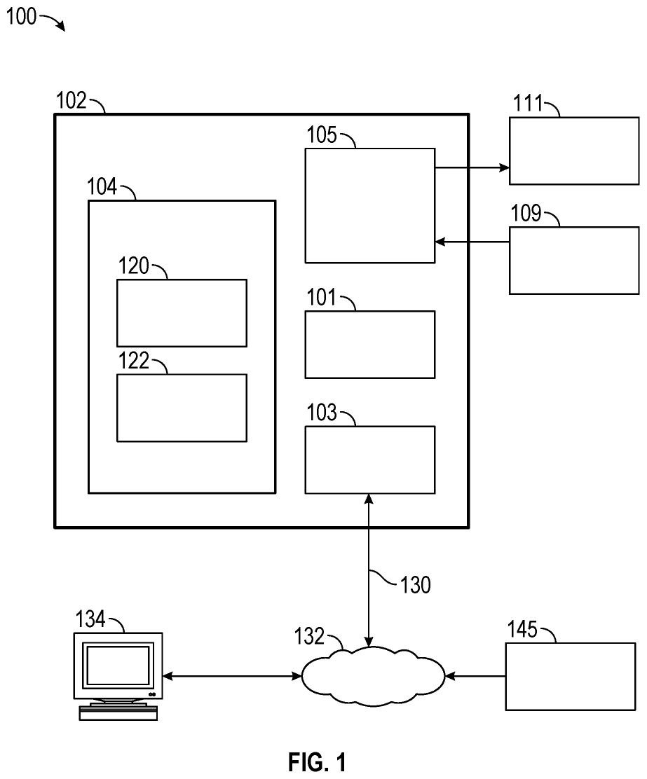

FIG. 1 shows an example optimization system 100 operable to implement techniques of the present disclosure. The system 100 may include a computer system 102, which may be a server, a network of servers or resources, a desktop personal computer, a portable laptop computer, another portable device, a mini-computer, a mainframe computer, a storage system, a dedicated digital appliance, or another device having a storage sub-system configured to store a collection of digital data items. In one implementation, the computer system 102 may include one or more processor(s) 101, a network controller 103, non-transitory computer-readable media 104, an input/output interface 105, one or more input devices 109 (e.g., keyboard, mouse, touch screen, tablet, etc.), and one or more output devices 111 (e.g., monitor or display). Various other peripheral devices, such as an additional data storage device and a printing device, may also be connected to the computer system 102.

Non-transitory computer-readable media 104 may include random access memory (RAM), read only memory (ROM), magnetic floppy disk, disk drive, tape drive, flash memory, etc., or a combination thereof. The present disclosure may be implemented using an autoencoder 120 and one or more surrogate model(s) 122 that may include computer-readable program code tangibly embodied in the non-transitory computer-readable media 104 and executed by the processor(s) 101. As such, the computer system 102 may be a general purpose computer system that becomes a specific purpose computer system when executing the routine of the present disclosure. The computer-readable program code is not intended to be limited to any particular programming language and implementation thereof. It will be appreciated that a variety of programming languages and coding thereof may be used to implement the teachings of the disclosure contained herein. The computer system 102 may also include an operating system and micro instruction code. The various processes and functions described herein may either be part of the micro instruction code or part of the application program or routine (or combination thereof) which may be executed by the processor(s) 101 via the operating system.

The computer system 102 may be connected, via network 132 using a communication link 130, to one or more client workstations 134 and data source 145. The communication link may be a telephone, a wireless network link, a wired network link, or a cable network. The network 132 may be wired or wireless and may include a local area network (LAN), a wide area network (WAN), or a combination thereof. The client workstation 134 may include a computer and appropriate peripherals, such as a keyboard and display, and may be operated in conjunction with the entire system 100. For example, the client workstation 134 may further include a memory to store information (e.g., input model parameter sets, a problem to be solved, a set of requirements for a plurality of objective functions related to the problem, etc.) that defines the inverse or optimization problem to be solved by the computer system 102. The client workstation 134 may further include a user interface to allow a user (e.g., customer or client) to interactively manipulate the retrieved and/or processed data. For example, the user may specify the problem to be solved and provide instructions to the computer system 102.

In addition, the client workstation 134 may be communicatively coupled, via the network 132, with the data source 145 so that the data stored or collected by the data source 145 may be retrieved by the client workstation 134. Alternatively, the data source 145 may be incorporated in the client workstation 134 or the computer system 102. In one implementation, the data source 145 may be a memory or other program storage device that stores digital observed data that may be used by the computer system 102 to predict model parameter sets. The data source 145 may also be a data acquisition system that is adapted to collect the digital observed data by quantifying observations of a physical system. For example, such digital observed data may be geophysical data, meteorological data or biomedical data. It should be understood that the present framework is not limited to data observed in a physical system. Non-physical systems, such as financial markets or business enterprises, may also be observed. For example, the observed data may include historical stock prices, commodity prices, currency values or other types of financial data collected for analyzing investment portfolios and predicting future performance. In addition, the observed data may be in any digital format, such as one-dimensional data or two- or three-dimensional images.

In one implementation, the data source 145 may be a data acquisition system that includes a signal sensor, detector, receiver, source, scanner or any other suitable device that is operable to digitize observations (e.g., images) of a physical system (e.g., Earth, atmosphere, biological body, etc.). In geophysical exploration applications, the data acquisition system 145 may be adapted to collect geophysical data such as seismic reflection data that can be used to compute quantitative parameters (e.g., velocity structure, elastic parameters, etc.) of rock terrains via seismic inversion techniques.

It is understood that other types of observed data may also be collected by the data acquisition system 145 for different applications. For instance, in the medical field, biological data such as electrophysiological data or radiological images (e.g., magnetic resonance (MR) or computed tomography (CT) images) may be collected to detect abnormal medical conditions (e.g., tumor or malignant growths). In the meteorology field, weather forecasting may be performed based on meteorological data indicative of precipitation, temperature, humidity values, cloud coverage, air quality, contamination dispersion, etc. In reservoir simulation models, historical production and pressure data may be collected to predict the flow of fluids (e.g., oil, water, gas) through porous media. Relevant model parameters may include, for example, permeability, porosity and saturation. Other types of applications may include, but are not limited to, biomolecular structural predictions, drug design, structural optimization, material design and nanotechnology, semiconductor design, chemo-metrics, and so forth.

The observed data (e.g., acquired or measured data) may be transmitted from the data source 145 (or the client workstation 134) to the computer system 102 for processing. Other types of information may also be sent to the computer system 102 for processing. For example, the client workstation 134 may provide an input model parameter set that is determined to be a possible solution candidate of a predefined problem (e.g., inverse or optimization problem). Alternatively, the client workstation 134 may provide prior information (or prior scenarios) from which the computer system 102 may extract the input model parameter set. In addition, the client workstation 134 may provide a mathematical model (e.g., forward model) that maps the input model parameter set to the observed data.

The autoencoder 120 and one or more surrogate model(s) 122 may be executed by the processor(s) 101 to process the observed data (e.g., measured or acquired data) and any input information provided. In one implementation, the surrogate model(s) 122 may be learned using the results of the evaluations that were used to train the autoencoder 120. The surrogate model(s) 122 may be used to explore the latent space and find new parameter assignments that are likely to be good solutions to the problem. The latent space is a lower-dimensional space than the space of all possible parameter assignments, so it may be easier to explore. The surrogate model(s) 122 may each be a special class of neural networks that are invertible.

It is to be further understood that, because some of the constituent system components and method steps depicted in the accompanying figures may be implemented in software, the actual connections between the systems components (or the method steps) may differ depending upon the manner in which the present disclosure is programmed. Given the teachings of the present disclosure provided herein, one of ordinary skill in the related art will be able to contemplate these and similar implementations or configurations of the present disclosure.

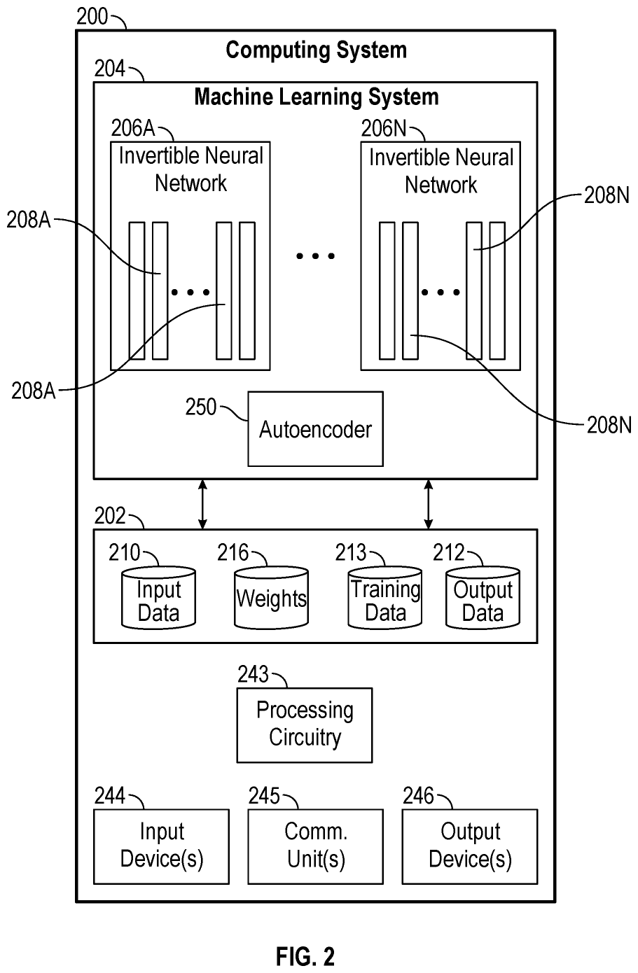

FIG. 2 is a block diagram illustrating an example computing system 200. In an aspect, computing system 200 may comprise an instance of the optimization system 100. As shown, computing system 200 comprises processing circuitry 243 and memory 202 for executing a machine learning system 204 having one or more invertible neural networks 206A-206N (collectively, “INNs 206”) comprising respective sets of layers 208A-208N (collectively, “layers 208”). Each of invertible neural networks 206 may comprise various types of neural networks, such as, but not limited to, recursive neural networks (RNNs), convolutional neural networks (CNNs) and deep neural networks (DNNs).

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. Computing system may represent an instance of computing system 102 of FIG. 1. INNs 206 may be example instances of surrogate model(s) 122 of FIG. 1, and autoencoder 250 may represent an example instance of autoencoder 120 of FIG. 1.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, autoencoder 250) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., autoencoder 250), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, autoencoder 250 may receive input data from an input data set 210 and may generate output data 212. Input data 210 and output data 212 may contain various types of information. For example, input data 210 may include a model parameter set that is determined to be a possible solution candidate of a predefined problem. Output data 212 may include reconstructed input data, a plurality of solutions to the predefined problem, and so on.

Each set of layers 208 may include a respective set of artificial neurons. Layers 208A for example, may include an input layer, a feature layer, an output layer, and one or more hidden layers. Layers 208 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer.

Each input of each artificial neuron in each layer of the sets of layers 208 is associated with a corresponding weight in weights 216. The output of the k-th artificial neuron in neural network 206 may be defined as:

yₖ=ϕ(Wₖ·Xₖ) (1)

In Equation (1), yₖ is the output of the k-th artificial neuron, ϕ(⋅) is an activation function, Wₖ is a vector of weights for the k-th artificial neuron (e.g., weights in weights 216), and Xₖ is a vector of value of inputs to the k-th artificial neuron. In some examples, one or more of the inputs to the k-th artificial neuron is a bias term that is not an output value of another artificial neuron or based on source data. Various activation functions are known in the art, such as Rectified Linear Unit (ReLU), TanH, Sigmoid, and so on.

Machine learning system 204 may process training data 213 to train the autoencoder 250, in accordance with techniques described herein. For example, machine learning system 204 may apply an end-to-end training method that includes processing training data 213. Machine learning system 204 may process input data 210 to generate a plurality of diverse solutions to a problem as described below.

In an aspect, INNs 206 are useful for parameter optimization because INNs 206 allow to explore the space of possible solutions in a more efficient way. In an aspect, INNs 206 may use latent space optimization, in which INNs 206 find good solutions to multi-objective optimization problems by exploring a lower-dimensional representation of the problem space. In an aspect, the latent space may be learned using the autoencoder 250. The autoencoder 250 may be trained to map the high-dimensional parameter space to a low-dimensional latent space. In other words, the autoencoder 250 may be trained to compress a plurality of parameters to generate a latent space representation. Once the autoencoder 250 generates a first latent representation, a set of surrogate models (e.g., INNs 206) may be learned to map the first latent representation to the different objective values. In an aspect, machine learning system 204 may be used to solve problems with a very large number of parameters, to solve problems with multiple objectives, and to find solutions that are diverse.

In the inverse direction, given the objective values and a random seed vector, the INNs 206 may generate a second latent representation. In other words, the INNs 206 may be used to generate a second latent representation that corresponds to a given objective value. The random seed vector may be used to add some randomness to the process, so that different latent representations may be generated for the same objective value.

In an aspect, a random seed vector may allow the machine learning system 204 to explore the space of possible second latent representations that may produce a given objective value, which may be helpful for generating, based on the second latent representation, a plurality of solutions to a problem that satisfy a set of requirements for the plurality of objective functions. For example, if the machine learning system 204 is being applied to design a vehicle, the machine learning system 204 may use the INNs 206 to generate a latent representation that corresponds to a given objective value, such as the vehicle's fuel efficiency. The machine learning system 204 may then use this second latent representation to design a vehicle that has the desired fuel efficiency. The different seed vectors may allow the machine learning system 204 to generate different latent representations for the same objective value. In other words, the machine learning system 204 may explore a wider range of possible solutions.

After training, given a new set of requirements for the objective functions (maximize, minimize, or meet some threshold) relating to a problem, the machine learning system 204 may use a guided random walk in the latent space to simultaneously satisfy the multiple objectives. In other words, the machine learning system 204 may be used to find a set of latent representations that simultaneously satisfy all of the given objective functions. The latent representation is a subspace of the input space that captures the underlying relationships between the data. By performing a guided random walk through the latent representation, the machine learning system 204 may explore different regions of the solution space and may generate a diverse set of solutions. To ensure that the generated solutions are balanced, the machine learning system 204 may apply a constraint to the random walk. This constraint may be based on any desired criteria, such as, but not limited to, the diversity of the solutions or the quality of the solutions.

In an aspect, a guided random walk may include a Markov Chain Monte Carlo walk. The Markov Chain Monte Carlo (MCMC) walk is a stochastic process that may be used to explore a probability distribution. In the described case, the probability distribution may be the distribution of latent representations that satisfy the given objective functions. The MCMC walk may start at a random latent representation and then may take a series of steps to explore the space of latent representations. The steps may be chosen randomly, but these steps are more likely to be taken in directions that are likely to lead to latent representations that satisfy the objective functions.

In an aspect, the diversity of the solutions may be achieved by controlling the entropy of the MCMC walk. The entropy is a measure of the randomness of the walk. A high entropy walk is more random and may explore a wider range of latent representations. A low entropy walk is less random and may explore a narrower range of latent representations.

The initial points selected by the random seeds of the INNs 206 may also affect the diversity of the solutions. The random seeds may be used to initialize the latent representations at the start of the MCMC walk. Different random seeds may lead to different initial latent representations, which may result in different walks and different solutions.

Conventional optimization systems typically use a single model to learn the mapping from the input space to the output space. Optimization using a single model may be difficult if the input space is high-dimensional and the mapping is complex.

In an aspect, the machine learning system 204 may use a combined model that consists of two parts: the autoencoder 250 and a set of INNs 206. The autoencoder 250 may be configured to learn the invariances/dependencies across all parameters in the input space. In other words, the autoencoder 250 may learn the relationships between the different parameters and how they affect the output data 212. The INNs 206 may be configured to map the latent space to different objectives. Accordingly, the INNs 206 may be used to generate different outputs for the same latent representation.

The machine learning system 204 having a combined model has several advantages over conventional optimization systems. First, the machine learning system 204 may learn constraints on the optimization problem from examples. In other words, the machine learning 204 may learn which parameters are important and which parameters are not important. Second, the INNs 206 may replace computationally expensive and slow black boxes with learned surrogates. Accordingly, the machine learning system 204 may be used to optimize problems that are too expensive to optimize using traditional methods. Third, the disclosed machine learning system 204 may scale to very high dimensions by learning a low dimensional latent space of the autoencoder 250. In other words, the machine learning system 204 may be used to optimize problems with a large number of parameters.

In an aspect, enabling exploration of the latent space may give users a knob to control whether to have more novel/different solutions or whether to optimize on the given cost objectives. If the user wants to find novel solutions, they may use a high entropy walk. If the user wants to optimize on the given cost objectives, the user may use a low entropy walk. Diversity may make solutions more robust to incompleteness of objectives because if there are multiple objectives, it is possible that some of the objectives may not be known or may not be fully understood. In this case, a diverse set of solutions is more likely to include solutions that are good for all of the objectives, even if some of the objectives are not fully known. In particular, the techniques of this disclosure may enable human-in-the-loop optimization where a human may provide preferences over the diverse solutions. Accordingly, a human may interact with the machine learning system 204 to provide feedback on the solutions that are being generated. Such human feedback may be used to improve the quality of the solutions or to explore different parts of the latent space.

When using machine learning to infer invariances and learn surrogates, purely data-driven models may produce incorrect predictions. Data-driven models are typically trained on a limited amount of data, and the data may not be representative of the entire problem space. As a result, the data-driven models may make mistakes when they are asked to predict the output for a new input that is outside of the training data. Such mistakes may lead to the discovery of incorrect optimal points. To address the aforementioned problem, the machine learning system 204 may quantify the uncertainty of predictions. In other words, the machine learning system 204 may estimate how likely it is that a given prediction is correct.

The uncertainty of predictions may be quantified by the machine learning system 204 using a variety of methods, such as Bayesian inference. Bayesian inference is a statistical method that may take into account the uncertainty of the data and the model. By quantifying the uncertainty of predictions, the machine learning system 204 may detect when it needs to gather more data in some parameter space. The machine learning system 204 may be more uncertain about its predictions in areas where it has not seen much data. The machine learning system 204 may also use the uncertainty of predictions to guide its exploration of the latent space. The machine learning system 204 may focus its exploration on areas where the predictions are more uncertain, as these are the areas where it is more likely to find new and interesting solutions.

An objective function is a function that maps from a set of input parameters to a scalar output. The output of the objective function is typically a measure of the quality of the design. A black-box objective function is an objective function that may not be available in an analytical form. In other words, the objective function may not be expressed as a mathematical equation.

The INNs 206 may be used to work with black-box objective functions by approximating the behavior of the objective function. Such approximation may allow the machine learning system 204 to optimize the design without having to know the analytical form of the objective function. Deep neural networks (DNNs) are a type of machine learning model that may be used to learn complex relationships between data. Accordingly, DNNs may be well-suited for approximating the behavior of black-box objective functions. In addition to approximating the behavior of black-box objective functions, DNNs may also be used to accelerate the evaluation of objective functions because DNNs may be trained to predict the output of the objective function from a set of input parameters. In other words, the objective function does not need to be evaluated every time the machine learning system 204 system needs to make a decision.

As noted above, the techniques of the present disclosure may enable configuring parameters for large scale systems with a very large number of parameters (e.g., 100s) with a large number of objective functions (e.g., 10s). The disclosed techniques may use a combination of invertible neural networks and machine learning to learn the relationship between the parameters and the objective functions. Such architecture may allow the machine learning system 204 to optimize the parameters without having to know the analytical form of the objective functions. The machine learning system 204 may be able to find multiple solutions for optimal parameters from which a configuration may be selected based on additional criteria or human preference because the machine learning system 204 may explore the space of possible solutions and find solutions that meet the user's requirements. The improvement may be in terms of the values of the objective functions as well as the diversity of produced solutions. In other words, the machine learning system 204 may find solutions that optimize the objective functions and also find solutions that are different from each other.

For example, if the machine learning system 204 is used to configure the parameters of a propulsion chain for an aircraft, the improvement may be measured in terms of the endurance, energy consumption, flight characteristics, electrical characteristics, and thermal characteristics of the aircraft. In the case of the example of deep learning model architecture, the impact may be improved accuracy, robustness to outliers, memory requirement, inference speed, and generalization across tasks.

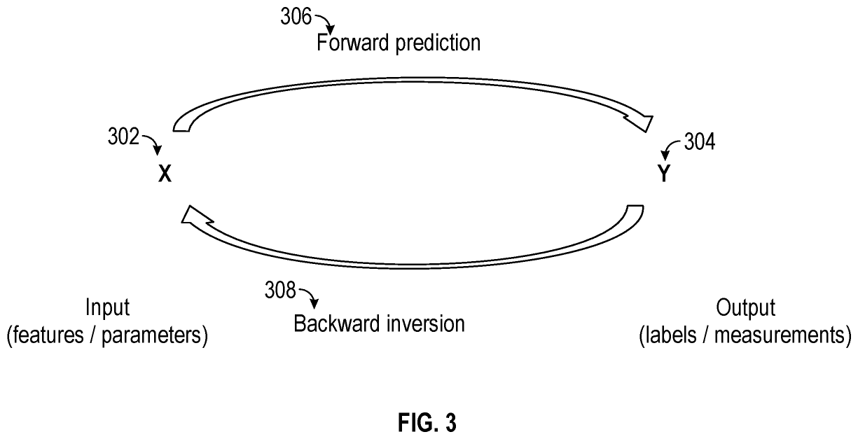

FIG. 3 is a conceptual diagram illustrating an example inverse problem design according to techniques of this disclosure. An inverse problem is a problem in which the goal is to determine the cause (or causes) of an observed effect. In the context of design problems, the inverse problem may be formulated as follows: given a desired outcome (or label), determine the design parameters that will produce that outcome. For example, if a goal is to design a vehicle that will be able to reach a top speed of 200 miles per hour, the inverse problem may determine the values of the vehicle's design parameters (such as, but not limited to, the engine size, the aerodynamics, and the weight) that may achieve this top speed.

Some specific examples of inverse problems in design may include but are not limited to: finding the design parameters of a bridge that will withstand a given load, finding the design parameters of a drug that will have a desired therapeutic effect, finding the design parameters of a financial instrument that will have a desired risk-return profile.

The inverse problem may be ill posed. In other words, there may be multiple design parameters that may produce the desired output 304 because the mapping from inputs 302 to outputs 304 may often be many-to-one. For example, there are many different ways to design a car that can accelerate from 0 to 60 miles per hour in 5 seconds. The forward prediction model 306 may be expensive and time-consuming to evaluate because the forward prediction model 306 may involve simulating the physical behavior of the system. In many cases, it may not be possible to evaluate the forward prediction model 306 for all possible sets of design parameters. The data may be noisy or incomplete. It is often difficult to collect accurate data about the system. The noise and incompleteness of the data may make it difficult to solve the inverse problem.

Advantageously, the inverse problem may be used to generate novel designs that would be difficult or impossible to find using the forward model alone. The inverse model may explore the space of possible designs and find designs that are not easily accessible using the forward prediction model 306. In addition, the inverse problem may be used to optimize designs. In an aspect, the inverse model having backward inversion 308 may be used to find the set of design parameters that minimizes a given cost function. For example, the cost function could be the weight of the design or the energy consumption of the design. As yet another advantage, the inverse problem may be used to automate the design process because the inverse model may be used to generate designs without human intervention. Such design process may be useful for applications where the design process is complex or time-consuming.

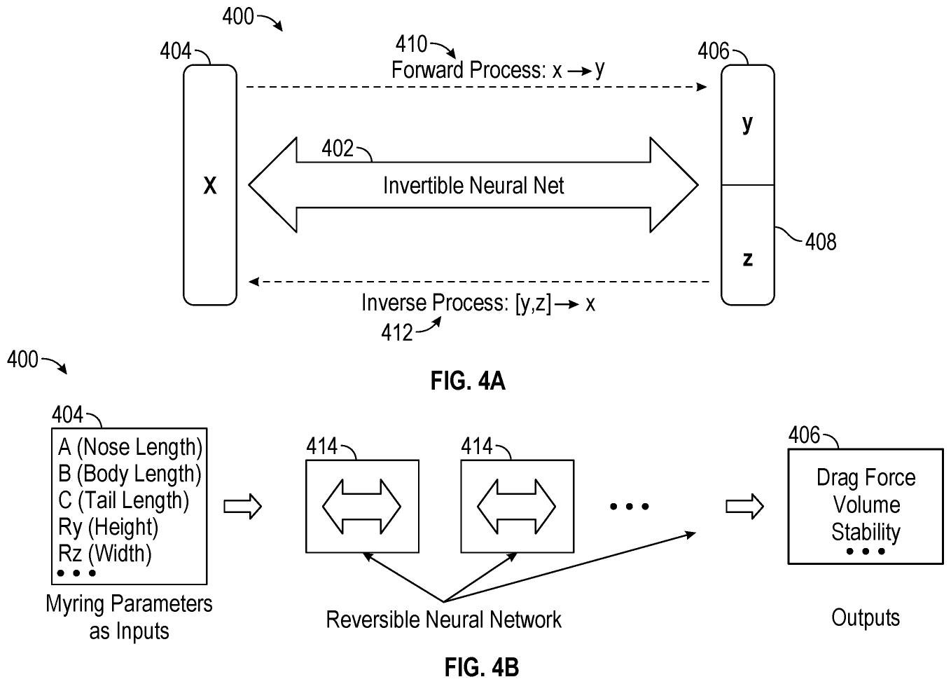

FIGS. 4A and 4B are conceptual diagrams illustrating example invertible neural net frameworks according to techniques of this disclosure. FIG. 4A illustrates the INN framework 400 that may include the INN 402 with inputs (X) 404, outputs (y) 406 and latent variable (z) 408.

The forward process function f (x->y) 410 is a function that maps from the input X 404 to the output Y 406. The forward process function 410 may be deterministic. In other words, given the same input X 404, the forward process function 410 will always produce the same output Y 406. However, there may be some information loss during the forward process because the output Y 406 may not contain all of the information that is present in the input X 404.

The latent variable Z 408 may be introduced to capture the information about the input X 404 that is not present in the output Y 406. This latent variable Z 408 may be a random variable that is generated by the INN 402. In an aspect, the INN 402 may then pass the latent variable Z 408 to the inverse process g (z->x) 412, which may map from the latent variable Z 408 to the input X 404.

The INN framework 400 may be used to solve inverse problems by learning the mapping from the input X 404 to the output Y 406 and from the output Y 406 to the input X 404. Such mappings may allow the INN 402 to learn the complex relationships between the input X 404 and the output Y 406, even if there is some information loss during the forward process 410.

As a non-limiting example, the INN framework 400 may be used to reconstruct an image from its corrupted measurements. The corrupted measurements may be represented as the output Y 406. The latent variable Z 408 may be used to capture the information about the original image that is not present in the corrupted measurements. The inverse process g (z->x) 412 may then be used to reconstruct the original image from the latent variable Z 408. The inverse process may be represented by the following equation (2):

x=f⁻¹(y,z)=g(y,z) (2)

where f⁻¹ and g are modeled by invertible neural networks.

As shown in FIG. 4B, INN framework 400 may consist of several reversible neural networks 414. In other words, each of the reversible neural networks 414 in the INN framework 400 may be inverted. This is in contrast to traditional neural networks, which are not reversible. The reversibility of the neural networks 414 in the INN framework 400 enables the machine learning system 204 to learn the inverse process 412 as well as the forward process 410.

In an aspect, the inversion may be obtained by design. In other words, the INN framework 400 may be specifically designed to be able to invert the forward process 410. Such design is in contrast to gradient-based inversion methods, which are not specifically designed for inversion. The INN framework's 400 ability to invert the forward process 410 by design makes it faster and more efficient than gradient-based inversion methods.

Compared to the gradient based inversion, the INN framework 400 has two key advantages: inversion is fast, and a distribution is learnt over the input space. As mentioned above, the INN framework 400 may be specifically designed to be able to invert the forward process 410. This design makes the INN framework 400 faster than gradient-based inversion methods, which need to perform an optimization procedure to find the inverse. Furthermore, the INN framework 400 may generate a diverse set of solutions for the inverse problem in contrast to gradient-based inversion methods, which typically only generate a single solution.

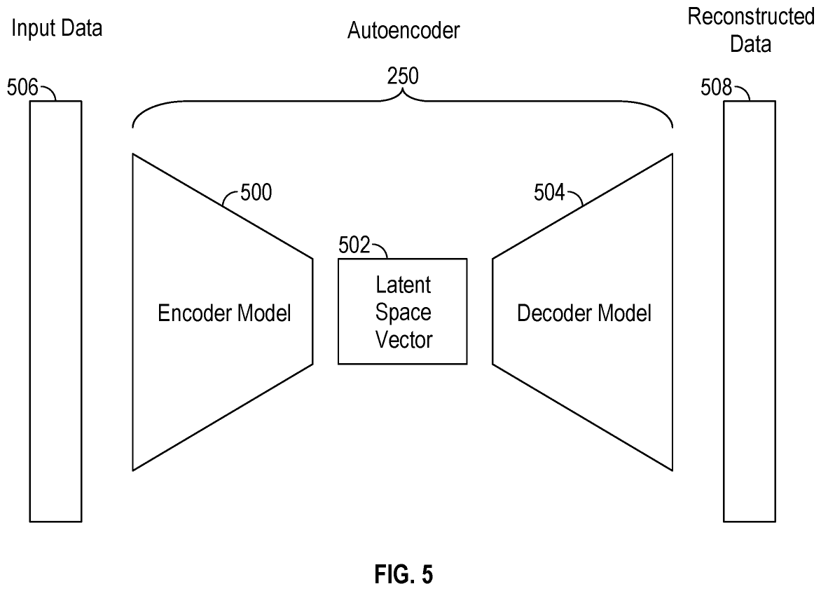

FIG. 5 is a conceptual diagram illustrating an example autoencoder 250 according to techniques of this disclosure. Other types of autoencoders may be used in the techniques of this disclosure. The autoencoder 250 is a type of neural network that learns to compress data into a latent space and then reconstruct the data from the latent space. As shown in the example of FIG. 5, the autoencoder 250 may include an encoder model 500, a latent space vector 502, and a decoder model 504. Encoder model 500 may comprise a neural network, such as a CNN or another type of neural network. The encoder model 500 may take the input data 506 and may compress the input data 506 into the latent space vector 502. The decoder model 504 may comprise a neural network, such as a deconvolutional neural network or another type of neural network. The decoder model 504 may take the latent space vector 502 and may reconstruct the input data 506. The latent space vector 502 may store the output of encoder model 500. The latent space vector 502 may be a lower-dimensional representation of the input data 506. The decoder model 504 may generate reconstructed data 508. The latent space vector 502 may include fewer features than either the input data 506 or the reconstructed data 508 because the encoder model 500 may learn to remove redundant information from the input data 506. The encoder model 500 and the decoder model 504 are typically trained together. In other words, the encoder model 500 may be learning to compress the data in a way that the decoder model 504 may reconstruct it. As noted above, the autoencoder 250 may be used to reduce the dimensionality of data without losing too much information.

The encoder model 500 may include a series of layers. The layers of encoder model 500 may include an input layer, one or more hidden layers, and an output layer. The hidden layers of the encoder model 500 may include one or more convolutional layers.

Convolutional layers work by applying a filter to the input data 506. The filter may be a small matrix of weights that is slid across the input data 506. The filter may calculate a dot product between itself and the input data 506 at each location. The output of the convolutional layer is a feature map that contains the results of the dot products. Neurons in a convolutional layer are not connected to each value in an input matrix of the convolutional layer. Rather, neurons in a convolutional layer are connected to values in a receptive field with the input matrix of the convolutional layer. A neuron in a convolutional layer (i.e., a convolutional layer neuron) performs a convolution, such as a dot product, to generate an output value based on values generated by neurons in the receptive field of the convolutional layer neuron and weights of connections between the convolutional layer neuron and the neurons in the receptive field of the convolutional layer neuron. The hidden layers of encoder model 500 may also include pooling layers, fully connected layers, or other types of layers. Pooling layers may be used to reduce the size of the feature maps by taking the maximum value, the average value, or another aggregate value of each region of the feature map. Each neuron in a pooling layer may have a receptive field and may output an aggregate value based on the values in the receptive field of the neuron. For instance, a neuron in a pooling layer may output a maximum value of the values in the receptive field of the neuron, an average of the values in the receptive field of the neuron, or another type of aggregate value. The final layer of the encoder model 500 may be a fully connected layer. A fully connected layer is a layer where each neuron is connected to all of the neurons in the previous layer. In an aspect, the fully connected layer may output the latent space vector 502.

The decoder model 504 may also comprise a CNN and may include a series of layers. The layers of decoder model 504 may include an input layer, one or more hidden layers, and an output layer. The hidden layers of the decoder model 504 may include one or more deconvolutional layers. Deconvolutional layers are also called transposed convolutional layers. Transposed convolutional layers work in the opposite way to convolutional layers. Transposed convolutional layers may take the latent space vector 502 as input and reconstruct the input data 506. The deconvolutional layers in the decoder model 504 work by applying a constraint to the latent space vector 502. In other words, the decoder model 504 may be constrained to only generate outputs that are consistent with the acceptable parameters. For example, a constrain may be used to ensure that the generated outputs are realistic or that they meet certain safety requirements. The hidden layers of the decoder model 504 may also include pooling layers. Pooling layers may be used to reduce the size of the feature maps by taking the maximum value, the average value, or another aggregate value of each region of the feature map. The final layer of the decoder model 504 may be a fully connected layer. A fully connected layer is a layer where each neuron is connected to all of the neurons in the previous layer. In an aspect, the fully connected layer may output the reconstructed data 508. A neuron in a deconvolutional layer, sometimes called “transposed convolution” layer, may generate an output value based on values in a padded receptive field and weights of connections between the neuron and locations in the receptive field of the neuron. The padded receptive field may include values generated by neurons in a previous layer of decoder model 504 and padding values. The padding values in the padded receptive field may be used to ensure that the output of the deconvolutional layer has the same size as the input data 506. The padding values may be zero values, but they may also be other values.

The input data 506 may be provided as input to encoder model 500. The input data 506 may include various types of information. The input data 506 to the encoder model 500 may be any data that may be represented as a sequence of data points. The input data 506 may include, but is not limited to, text, images, audio, or even time series data. The format of the input data 506 may also vary. Such format may include, but is not limited to, a simple list of numbers or a more complex structure, such as a tree or a graph. The decoder model 504 may then be used to reconstruct the original input data 506 from the latent space vector 502. The reconstructed data 508 may be in the same or different format as the input data 506. For example, if the input data 506 is text, the reconstructed data 508 may also be text. However, if the input data 506 is an image, the reconstructed data 508 may be a different image. The choice of whether to reconstruct the input data 506 in the same or different format may depend on the application. In some cases, it may be important to reconstruct the data in the same format as the input data 506. For example, if the input data 506 is text and the output data is also text, then it may be important to reconstruct the text accurately. In other cases, it may be more important to reconstruct the data in a format that is easier to use or understand. For example, if the input data 506 is an image and the output data 212 is a set of features, then it may be more important to reconstruct the features accurately, even if the image is not reconstructed perfectly. Following are a few non-limiting examples of the input data 506 and the reconstructed data 508. If the input data 506 is a sequence of words, such as a sentence or a paragraph, the reconstructed data 508 may be reconstructed text in a different language or dialect. If the input data 506 is a grid of pixels, such as a photograph or a painting, the reconstructed image 508 may be a reconstructed image in a different style or perspective.

In an aspect, the machine learning system 204 may train the autoencoder 250 to minimize differences between the input data 506 and the reconstructed data 508. For example, the machine learning system 204 may use the training data 213 to train autoencoder 250. The training data 213 may include training datasets. In an aspect, the machine learning system 204 may feed the training data 213 to the autoencoder 250 and may adjust the parameters of the autoencoder model 250 so that the reconstructed data 508 is as close as possible to the original input data 506. When training the autoencoder 250, the machine learning system 204 may apply the autoencoder 250 to input data in the training data 213 to generate reconstructed input data. The machine learning system 204 may then apply an error function to measure the difference between the input data 506 and the reconstructed data 508. The error function may be a loss function, such as, but not limited to, the mean squared error or the cross-entropy loss. In other words, the loss value may correspond to an amount of difference between the input data 506 and the reconstructed input data (reconstructed data 508). The machine learning system 204 may perform a backpropagation algorithm to update parameters (e.g., weights of connections between artificial neurons of the autoencoder 250) based on the loss value. The backpropagation algorithm works by starting at the output layer of the autoencoder 250 and propagating the error back through the autoencoder model 250 to the input layer. The weights of the connections between the neurons in the autoencoder 250 may then be updated to reduce the error. In this way, the machine learning system 204 may train both the encoder model 500 and the decoder model 504 of the autoencoder 250 so that the autoencoder 250 reconstructs the input data 506 as close as possible to the input data of the training datasets. The autoencoder 250 may then be used to compress the input data 506 or to extract features from the input data 506. The choice of the training data 213 may be important. The training data 213 may be representative of the data that the autoencoder 250 is expected to learn. The number of training data points may also be important. The more training data points, the better the autoencoder 250 may be able to learn the data.

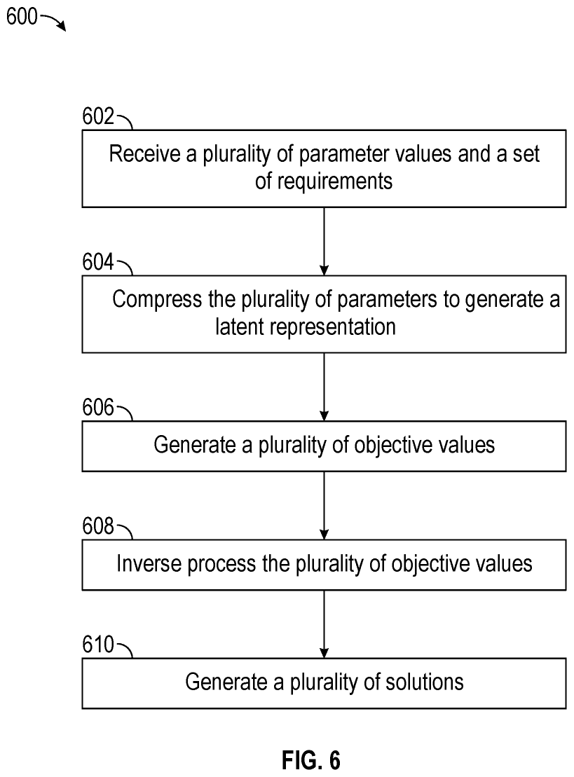

FIG. 6 is a flowchart illustrating an example mode of operation for a machine learning system, according to techniques described in this disclosure. Although described with respect to computing system 200 of FIG. 2 having processing circuitry 243 that executes machine learning system 204, mode of operation 600 may be performed by a computation system with respect to other examples of machine learning systems described herein.

In mode operation 600, processing circuitry 243 executes machine learning system 204. Machine learning system 204 may receive a plurality of parameter values and a set of requirements for a plurality of objective functions related to a problem (602). Machine learning system 204 may compress the plurality of parameters to generate a first latent representation (604) using the autoencoder 250. Machine learning system 204 may next forward process the first latent representation to generate a plurality of objective values corresponding to the plurality of the objective functions (606). In an aspect, the machine learning system 204 may forward process the first latent representation using one or more INNs 206. Next, machine learning system 204 may inverse process the plurality of objective values to generate second latent representation (608). In an aspect, the second latent representation may comprise reconstructed first latent representation generated by the one or more INNs 206. The machine learning system 204 may generate, based on the second latent representation, a plurality of solutions to the problem that satisfy the set of requirements for the plurality of objective functions (610).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method of designing a system or architecture comprising:
receiving a plurality of parameter values and a set of requirements for a plurality of objective functions related to a design problem;
compressing the plurality of parameters to generate a latent representation;
forward processing, with one or more Invertible Neural Networks (INNs), the latent representation to generate a plurality of objective values corresponding to the plurality of the objective functions;
inverse processing, with the one or more INNs, the plurality of objective values; and
generating, based on the latent representation, a plurality of solutions to the design problem that satisfy the set of requirements for the plurality of objective functions.

2. The method of claim 1, wherein compressing the plurality of parameters comprises compressing the plurality of parameters using an autoencoder.

3. The method of claim 1, wherein the plurality of parameters comprises a high-dimensional space and wherein the latent representation comprises a low-dimensional space.

4. The method of claim 2,
wherein the autoencoder comprises an encoder model and a decoder model, and
wherein the autoencoder is pretrained to learn interdependencies among the plurality of parameters.

5. The method of claim 4, wherein the latent representation comprises a latent space vector.

6. The method of claim 5,
wherein the decoder model of the autoencoder is configured to apply a constraint to the latent space vector, and
wherein the constraint identifies a set of acceptable parameters.

7. The method of claim 1, wherein the one or more INNs comprise one or more Deep Neural Networks (DNNs) trained to evaluate the plurality of objective functions.

8. The method of claim 1, wherein generating the plurality of solutions further comprises performing a guided random walk through the latent representation that generates a balanced set of solutions.

9. The method of claim 1, wherein, during the inverse processing, the one or more INNs are configured to generate the latent representation using a random seed vector.

10. The method of claim 1, wherein the plurality of parameter values comprises at least one of: biological data, meteorological data, or geophysical data.

11. A method of designing a system or architecture comprising:
receiving a set of parameters and a set of requirements for one or more objectives of a design problem;
processing, using a machine learning model, a latent representation comprising the set of parameters to determine one or more optimal designs of the system or architecture that satisfy the set of requirements; and
outputting the one or more optimal designs of the system or architecture that satisfy the set of requirements.

12. The method of claim 11, further comprising:
generating the latent representation using the set of parameters.

13. A computing system comprising:
an input device configured to receive a plurality of parameter values and a set of requirements for a plurality of objective functions related to a design problem;
processing circuitry and memory for executing a machine learning system, wherein the machine learning system is configured to:
compress the plurality of parameters to generate a latent representation;
forward process, with one or more Invertible Neural Networks (INNs), the latent representation to generate a plurality of objective values corresponding to the plurality of the objective functions;
inverse process, with the one or more INNs, the plurality of objective values; and
generate, based on the latent representation, a plurality of solutions to the design problem that satisfy the set of requirements for the plurality of objective functions.

14. The computing system of claim 13, wherein the machine learning system configured to compress the plurality of parameters is further configured to compress the plurality of parameters using an autoencoder.

15. The computing system of claim 13, wherein the plurality of parameters comprises a high-dimensional space and wherein the latent representation comprises a low-dimensional space.

16. The computing system of claim 14, wherein the autoencoder comprises an encoder model and a decoder model, and
wherein the autoencoder is pretrained to learn interdependencies among the plurality of parameters.

17. The computing system of claim 16, wherein the latent representation comprises a latent space vector.

18. The computing system of claim 17, wherein the decoder model of the autoencoder is configured to apply a constraint to the latent space vector, and
wherein the constraint identifies a set of acceptable parameters.

19. The computing system of claim 13, wherein the one or more INNs comprise one or more Deep Neural Networks (DNNs) trained to evaluate the plurality of objective functions.

20. Non-transitory computer-readable media comprising machine readable instructions for configuring processing circuitry to:
receive a plurality of parameter values and a set of requirements for a plurality of objective functions related to a design problem;
compress the plurality of parameters to generate a latent representation;
forward process, with one or more Invertible Neural Networks (INNs), the latent representation to generate a plurality of objective values corresponding to the plurality of the objective functions;
inverse process, with the one or more INNs, the plurality of objective values; and
generate, based on the latent representation, a plurality of solutions to the design problem that satisfy the set of requirements for the plurality of objective functions.
